(19) United States
(12) Patent Application Publication
(10) Pub. No.: US 2022/0257447 A1
(43) Pub. Date: Aug. 18, 2022

(54) FUNERAL PRODUCTS AND PROCEDURES

(71) Applicant: Tracy M. Sallah, Holland, OH (US)

(72) Inventor: Tracy M. Sallah, Holland, OH (US)

(21) Appl. No.: 17/666,960

(22) Filed: Feb. 8, 2022

Related U.S. Application Data
(60) Provisional application No. 63/148,643, filed on Feb. 12, 2021.

(51) Int. Cl. A61G 17/02; B41M 3/12

(52) U.S. Cl. CPC A61G 17/02; B41M 3/12

(57) ABSTRACT

The present invention includes a method of conducting a funeral service by supplying a decal to a funereal attendee for inscribing a handwritten memorial and affixing the decal to a burial receptacle such as a casket or urn. Preferably, the decal has a textured surface with a background depiction and has an adhesive that allows the decal to be removable. A relatively small decal is preferred such that many may be placed on a casket or urn.

### CROSS-REFERENCE TO RELATED APPLICATIONS

This application claims the benefit of U.S. Provisional Application No. 63/148,643, filed Feb. 12, 2021, the disclosure of which is incorporated herein by reference.

### FIELD OF THE INVENTION

This invention relates in general to funerals and more particularly to personalized burial containers.

### BACKGROUND OF THE INVENTION

Millions of people die each year worldwide and most all require a burial container such as a coffin or urn. Burial services for pets/animals also are becoming more common. In recent years, the traditional funeral ceremony is being replaced with a more celebratory ceremony often emphasizing certain attributes of the deceased's life. As a result, there has been an increasing demand to customize or personalize coffins as a way of highlighting those aspects that were important in the life of the deceased. Typical funerals do not provide attendees a way to express condolences, grief or memories to loved ones. Flowers and charitable donations in the name of a deceased are traditional.

Customized coffins with printed graphic images printed are commercially available. Such coffins are generally printed with an image of the deceased or a design of choice requiring manipulation of the coffin. Some manufacturers print images on paper and then apply the paper material to the coffin. However, the printed paper requires cutting around the sections of the coffin which may cause the manufacturing process to be slow and expensive. Also, the process of removing panels for adhesion of the images is expensive. Consequently, there is a need to provide a method of personalizing coffins which eliminates or mitigates the disadvantages of design delays and expense.

### SUMMARY OF THE INVENTION

The present invention provides a method for providing funeral attendees an additional and personal way of expressing thoughts. With this invention, the coffin may be in the form of a traditional coffin, casket, or urn and one or more decals attached to the sides, ends, or top, and the container does not need to be manipulated. As used herein, the terms “container” and “burial container” refer to caskets, coffins, burial urns, and the like, and the term “decals” includes labels with a removable liner covering an adhesive as well as stickers including a moisture activated adhesive without a liner covering.

The present invention includes a method of conducting a funeral service by providing a decal to a funereal attendee for inscribing a handwritten memorial and affixing the decal to a burial receptacle such as a casket or urn. Preferably, the decal has a textured surface with a background depiction and has an adhesive that allows the decal to be removable. A relatively small decal is preferred such that many may be placed on a casket or urn.

Various additional aspects of this invention will become apparent from the following detailed description.

### BRIEF DESCRIPTION OF THE DRAWINGS

FIGS. 1-3 illustrate various possible shapes of decals of the present invention,

FIG. 4 is perspective view of a casket having decals.

FIG. 5 is a perspective view of a burial urn having decals,

FIG. 6 is a cross sectional side view of a decal of the present invention,

FIG. 7 is a bottom view of a decal of the present invention having a two piece liner.

### DETAILED DESCRIPTION OF PREFERRED EMBODIMENTS

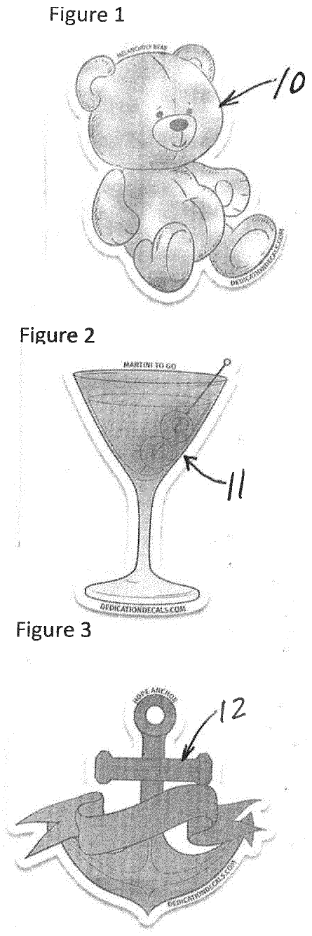

Referring to FIGS. 1-3, various shapes of decals are shown. FIG. 1 illustrates a teddy bear shaped decal 10 entitled “Melancholy Bear.” FIG. 2 illustrates a martini glass shaped decal 11 entitled “Martini to Go.” FIG. 3 illustrates an anchor shaped decal 12 entitled “Hope Anchor.” The customized decals include an appropriate image printed onto a vinyl-based media. Handwritten inscriptions are provided on several decals by funeral attendees by any suitable base writing instrument, such as paint, pen, felt tip marker or crayon, making each decal unique on its own and by end means based on the written inscription thereon.

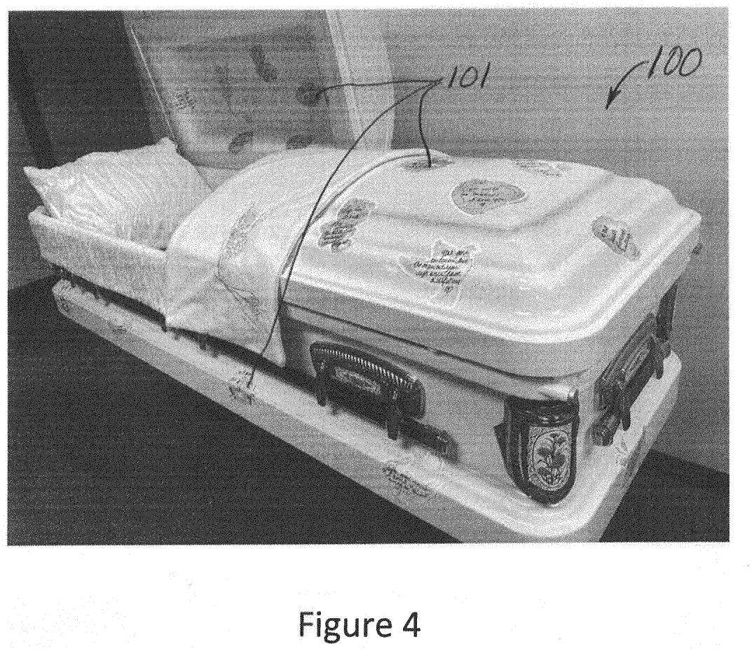

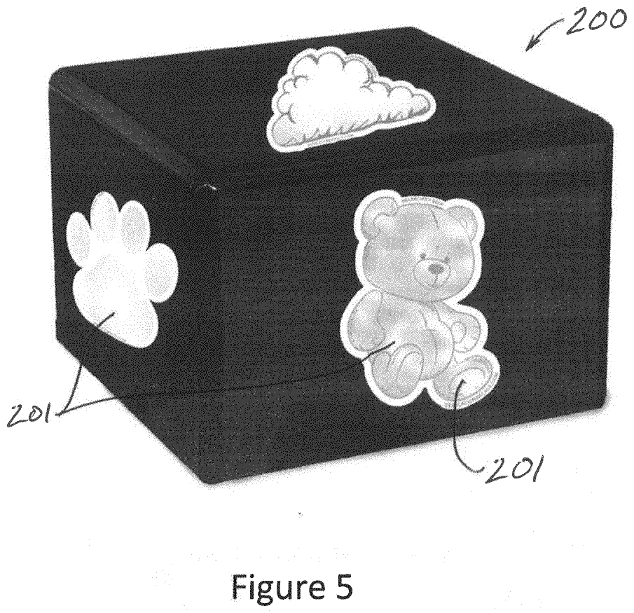

FIG. 4 shows a customizable casket 100 including several decals 101 attached to the inner surface, which may be fabric, and outer surfaces of the lid and top and side outer surfaces of the casket. FIG. 5 shows a customizable burial urn 200 having serval decals 201 attached to the outer surface of the urn and the urn lid.

Standard coffins are about 24 inches wide and about 79 inches long. A preferred decal size is about 5 inches by about 7 inches, or 30-40 square inches for a casket. Burial urns may have various sizes, typically around 100 to 240 cubic inches. Smaller decal may be best for urns, around 1-20 square inches each.

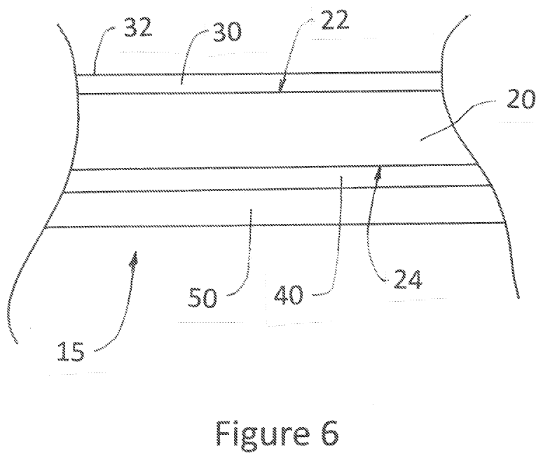

Referring to FIG. 6, decal 15 has a vinyl layer 20 having a top surface 22 and a bottom surface 24. The vinyl layer 20 has a thickness of about 3-6 mils. The top surface 22 may be coated with a clay or similar substance 30 which provides a textured surface 32. The slip resistant, non-skid topcoat is applied by spraying and has a thickness of about 0.5 to about 2 mils. An image, such as those shown in FIGS. 1-3, is printed on the topcoat surface 32 or on the top vinyl surface 22 if no top coating is used.

An adhesive 40 is to the bottom surface 24. The adhesive has a thickness of about 0.5-1.5 mils. A liner 50 is provided over the adhesive 40 to prevent the decal from adhering to anything before the liner is removed. The adhesive may be of the permanent or releasable variety as will be explained. A permanent adhesive will resist removal after liner is removed and the decal is applied to another surface. The liner has a thickness of about 1-4 mils.

### First Preferred Embodiment

A 3.2 mil thickness soft gloss white vinyl features a sprayed-on topcoat designed for use with a wide variety of ink systems as well as thermal transfer printing. This soft white vinyl film provides excellent tear strength, low temperature performance, dimensional stability, opacity, and chemical resistance. The film is coated with a slip resistant, non-skid textured surface sealant, typically clay, to impart certain qualities to the paper, including weight, surface gloss, smoothness, and reduced ink absorbency. Decal designs are printed on the topcoat. The topcoat also readily accepts handwritten messages and depictions. The applied topcoat is designed for use with a wide variety of ink systems as well as thermal transfer printing. The coating reduces dot gain by not allowing the ink to absorb into the paper.

A high-performance removable acrylic pressure sensitive adhesive is applied to the bottom surface of the vinyl. The adhesive has a 0.7 mil thickness and provides a moderate level of tack (ASTM D6252 Standard Test Method for Peel Adhesion) so that the vinyl is easily removable from most surfaces. The acrylic emulsion adhesion is a high clarity, high performance acrylic pressure sensitive adhesive providing clean, smooth removability from most surfaces, including glass, metal, painted surfaces, and plastics, with minimal peel build over time. It forms a water-resistant film after drying and improves abrasion resistance, washability and resistance to sunlight, weather, and heat. Adhesive application minimum temperature of 40 degrees Fahrenheit.

A preferred removable adhesive has (on a stainless steel substrate) loop tack of 0.4 to 0.8 lbs., preferably about 0.6 lbs. (TLMI-LIB 1, 1 mil polyester face stock, 1 mil of adhesive), shear of 24 hours or more (ASTM-D-3654, PSTC-7, 1 mil polyester face stock, 1 mil of adhesive, 1″×1″ with 1000 gm static load), peel adhesion of 0.5 to 1.5 lbs., preferably about 1.0 lbs. (ASTM-D-3330, PSTC-1, 1 mil of adhesive)

A 3.1 mil thickness bleached super calendared kraft paper stock liner covers the bottom surface of the vinyl. The liner may be in one or more segments.

### Second Preferred Embodiment

A 5.0 mil textured matte clear non-top coated vinyl face is rolled on the vinyl surface, and provides excellent tear strength, low temperature performance, good dimensional stability, chemical resistance, and printability. The clear vinyl has a textured matte printable top surface that readily accepts handwritten inscriptions.

A permanent acrylic pressure sensitive adhesive is applied providing excellent optical clarity, UV resistance, low temperature adhesion and water/humidity resistance. The substrate adhesion consists of stainless steel, glass, and HDPE, a low surface energy plastic that chemically reacts with the surface of the materials they are applied to in order to form a bond. The adhesive acrylic emulsion has a 1.1 mil thickness and provides a moderate level of tack (ASTM D6252 Standard Test Method for Peel Adhesion), so that the vinyl is easily removable from most surfaces, while resisting edge ooze and provides exceptionally clean die cutting and matrix stripping. It maintains clarity in hot and humid environments and is suitable for application with exposure to high temperature processes. The acrylic polymer application consists of Ethyl hexyl acrylate, n-Butyl acrylate and Iso-octyl acrylate. The stainless-steel substrate has a 2.0 lbs. loop tack measured by TLMI-LIB 1. Acrylic emulsion adhesion forms a water-resistant film after drying and improves abrasion resistance, washability and resistance to sunlight, weather, and heat. Adhesive application minimum temperature of 25 degrees Fahrenheit.

A preferred permanent adhesive has (on a stainless-steel substrate) loop tack of 1.5 to 2.5 lbs., preferably about 2.0 lbs. (TLMI-LIB 1, 1 mil polyester face stock, 1 mil of adhesive), shear of 5 hours or more (ASTM-D-3654, PSTC-7, 2 mil polyester face stock, 1 mil of adhesive, ½″×½″ with 500 gm static load), peel adhesion of 3.5 to 4.5 lbs., preferably about 4.1 lbs. (ASTM-D-3330, PSTC-1, 1 mil of adhesive).

A 1.2 mil thickness clear water insensitive polyester liner covers the bottom surface of the vinyl. The liner may be in one or more segments.

### Third Preferred Embodiment

Alternatively, the adhesive of the described embodiments may be replaced by a moisture activated adhesive, thereby eliminating the need for a liner. Water activated tape (WAT or Gummed as it is sometimes described in the industry) may be used. These typically are formulated from either natural polymers: from vegetable sources (dextrins, starches), protein sources (casein, blood, fish, soybean, milk albumen), and animal sources (hides, bones); or soluble synthetic polymers, including polyvinyl alcohol, cellulose eithers, methylcellulose, carboxymethylcellulose, and polyvinylpyrrolidone.

Funeral Service Provider System

The method of this invention includes providing decals to funeral service providers such as funeral homes or the clients/families/loved ones of the deceased. Core procedures for this method are supported by tools such as person to person demonstrations, sales decks, web-based software, and/or hard copy marketing presentations. The sales deck may assist funeral service providers such as funeral homes with a comprehensive list of customized decals which can be included in a marketing catalog for client/family inclusion in the memorial service.

In practice, persons, families, groups, organizations, etc. may purchase the customized decals, proceed to the place of morning, memorial, spiritual reflection, or worship, such as a mortuary, church, residence, or other of the deceased. Decals can be inscribed upon before or during a memorial service and applied to the burial container. The location for the inscription process may be determined by a family member, funeral director, etc. in a suitable, agreed upon location. The decals may then be selectively fixed on the container in a desired location. The decals may be moved, removed, or remain on the container for burial.

Decals may be accessible online, allowing users to select from an image library or database of decals. Users may upload personal illustrations for custom decal printing. Sets of decals may be offered in resealable poly bags with an insert card which may include a “My Story” description of the conception of the invention a step by step explanation of the method used when personalizing the decals, the application process for placing decals on a burial artifact and the ability to remove the decals for memorialization.

Decals

Each decal has a first surface with a texture for accepting handwritten inscriptions. The first surface may be topcoated or non-topcoated. Each decal has a second surface opposite the first surface coated with adhesive and an optional liner covering the adhesive.

The removability of this product is unique. The adhesive is of high clarity, high performance removable acrylic, pressure sensitive adhesive engineered to provide clean, smooth removability from most surfaces, including glass, metal, painted surfaces, and plastics, with minimal peel build over time.

Each decal is designed for high-speed die cutting for a peel and press process which offers a perfect and unique look of the custom decal.

If the decal is not topcoated, designs are printed directly on the base vinyl film which has a flat surface for superior image quality. The cast vinyl film guards against scuffs and is cleanable, effortlessly fresh. The crisp, uniform pattern adds depth to the look and feel of custom decal graphics. Designs printed on the base film and will not shrink. The face of the sticker bears printed information.

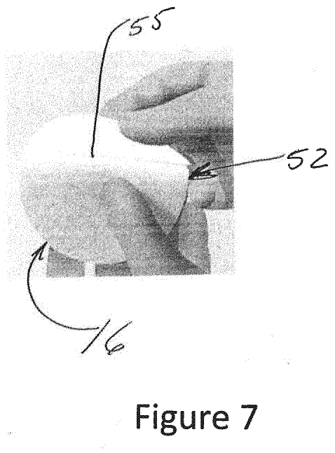

FIG. 7 is an illustration of a decal/sticker 16 having a two-piece liner 52. The two pieces of the liner 52 are separated by a fold line 55. This allows the adhesive to be exposed on demand by an easy, desirable manual process that involves folding the form along the fold line. When the form is unfolded, the liner can be removed and the decal applied to a casket or urn.

The principle and mode of operation of this invention have been explained and illustrated above. However, this invention may be practiced otherwise than as specifically explained and illustrated without departing from its spirit or scope.

What is claimed is:

1. A method of conducting a funeral comprising the steps of:
providing a burial container,
providing a decal to a funeral attendee to be attached to the burial container, and
attaching the decal to the burial container.

2. The method of claim 1 further comprising providing a marking instrument to the funeral attendee to mark on the decal.

3. The method of claim 1 wherein the decal has a top surface and a bottom surface, wherein the bottom surface includes an adhesive.

4. The method of claim 3 wherein the adhesive is a removable adhesive.

5. The method of claim 3 wherein the adhesive is a permanent adhesive.

6. The method of claim 3 wherein the decal further comprises a removable liner covering the adhesive.

7. The method of claim 6 wherein the removable liner has two segments.

8. The method of claim 3 wherein the decal is a sticker and wherein the adhesive is activated by moistening.

9. The method of claim 3 wherein the top surface includes a coating.

10. The method of claim 9 wherein the top surface coating is textured.

11. A burial container comprising a surface and a decal positioned on the surface, the decal including a printed background depiction, the decal having a top surface and a bottom surface, the bottom surface including an adhesive, and the top surface including a handwritten inscription.

12. The burial container of claim 11 wherein the decal is removable.

13. The burial container of claim 11 wherein the decal is about 4 to 8 inches wide and about 4 to 8 inches high.

14. The burial container of claim 11 wherein the decal is a sticker with a moisture activated adhesive.

15. The burial container of claim 11 wherein the decal top surface is spray coated to provide a texture.

16. The burial container of claim 15 wherein the decal surface is spray coated with a clay substance to create the texture.

17. The burial container of claim 11 wherein the burial container incudes a lid having an inner surface and an outer surface, and wherein the decal is positioned on the inner surface of the burial container lid.

18. The burial container of claim 11 wherein the decal is vinyl.

19. The burial container of claim 11 wherein the decal incudes a personalized message or depiction hand marked by a funeral attendee.

20. The burial container of claim 12 wherein the removable adhesive has (on a stainless steel substrate) loop tack of 0.4 to 0.8 lbs.
